(19) United States
(12) Patent Application Publication
(10) Pub. No.: US 2026/0245451 A1
(43) Pub. Date: Aug. 20, 2026

(54) DISPLAY DEVICE AND DETECTION METHOD FOR TOUCH OPERATION AND REMOTE CONTROL OPERATION

(71) Applicant: SHARP KABUSHIKI KAISHA, Sakai City (JP)

(72) Inventors: KOHICHI SUGIYAMA, Sakai City (JP); Motomitsu Itoh, Sakai City (JP)

(21) Appl. No.: 19/536,557

(22) Filed: Feb. 11, 2026

(30) Foreign Application Priority Data
Feb. 18, 2025 (JP) 2025-024350

(51) Int. Cl. G08C 23/04

(52) U.S. Cl. CPC G08C 23/04

(57) ABSTRACT

A display device, includes: a display including a display surface; an infrared light emitting element provided at an outer peripheral portion of the display surface; an infrared light receiving element that is allowed to detect infrared light and a remote control optical signal; a touch operation detector that detects a touch operation on the display surface; a remote control signal detector that detects the remote control optical signal; and a process performer that performs a first process based on detection of the touch operation and performs a second process based on detection of the remote control optical signal, wherein the process performer does not perform the first process even when the touch operation detector detects the touch operation for a predetermined period after the remote control optical signal is detected.

### CROSS-REFERENCE TO RELATED APPLICATION

The present application claims priority from Japanese Application JP2025-024350, the content to which is hereby incorporated by reference into this application.

### BACKGROUND OF THE INVENTION

### 1. Field of the Invention

The disclosure relates to a display device in which a touch operation can be detected and a signal from an infrared remote controller can be detected using infrared light, and a detection method for a touch operation and a remote control operation.

### 2. Description of the Related Art

In recent years, display devices including an infrared light blocking type touch panel have been widely used. The display device is often used for a relatively large display device such as a display for a conference or an electronic blackboard, but is not limited thereto. For example, the display device is also used for an information display (also referred to as a signage display) installed at public facilities such as transportation facilities, commercial facilities, and the like. In such a display device, settings and operations are often accepted using an infrared remote controller.

In the infrared light blocking type touch panel, an infrared light emitting element such as an LED and an infrared light receiving element such as a phototransistor are used for detecting a touch operation, and intermittent light emission is performed in order to avoid an influence of sunlight or illumination. An infrared light emitting element such as an LED is also used for the infrared remote controller, and a light receiver of a remote control optical signal is provided on the display device side. In sending a remote control optical signal as a command, the infrared remote controller intermittently emits light in order to avoid the influence of sunlight or illumination. The optical signal of the infrared remote controller is intermittently emitted at a frequency of several tens of kHz, whereas infrared light for detecting a touch operation is intermittently emitted at a frequency of several hundreds of Hz to several kHz, so as to be designed to be unlikely to interfere with each other. However, even when the fundamental frequencies of the two are different from each other, interference may occur at a multiplied frequency, and detection may become unstable. Therefore, a technique is known for reducing light emission intensity of an infrared light emitting element of a touch panel when a period in which the touch panel is not operated exceeds a predetermined time, and original light emission intensity is resumed when a predetermined condition is satisfied, thereby making it difficult for infrared light from the touch panel to become disturbance noise in a light receiver of an infrared remote controller.

### SUMMARY OF THE INVENTION

In recent years, touch displays with narrow frames have become widespread. The touch displays with narrow frames give an advanced impression to users, but since a position to which a remote control signal light receiver is mounted is limited, a viewing angle at which an optical signal from an infrared remote controller can be received becomes narrow, which causes a problem that a response to the remote control optical signal from the infrared remote controller may become unstable. However, it can be said that interference between an optical signal of an infrared remote controller and infrared light from an infrared light emitting element of a touch panel suggests commonality between the two from a different viewpoint. Not only is it possible to take defensive measures such as preventing interference, but it may also be possible to stably receive an optical signal from the infrared remote controller by positively utilizing the commonality between the two, or to support a remote controller of a system different from a basic remote controller or a remote controller that supports only a remote control optical signal of a specific content.

The disclosure has been made in view of the above circumstances, and achieves a stable and easy to use display device that makes it possible to stably receive a remote control optical signal from an infrared remote controller by using hardware related to detection of a touch operation, or to expand a range of remote control optical signals that can be supported.

The disclosure provides a display device including a display including a display surface, an infrared light emitting element provided at an outer peripheral portion of the display surface, an infrared light receiving element that is provided at a position facing the infrared light emitting element at the outer peripheral portion of the display surface and is allowed to detect infrared light emitted from the infrared light emitting element and a remote control optical signal being infrared light emitted from an external infrared remote controller, a touch operation detector that detects a touch operation on the display surface based on detection of the infrared light by the infrared light receiving element, a remote control signal detector that detects the remote control optical signal based on detection of the infrared light by the infrared light receiving element, and a process performer that performs a first process based on detection of the touch operation by the touch operation detector and performs a second process based on detection of the remote control optical signal by the remote control signal detector, wherein the process performer does not perform the first process even when the touch operation detector detects the touch operation for a predetermined period after the remote control optical signal is detected by the remote control signal detector.

Further, from a different viewpoint, the disclosure provides a detection method for a touch operation and a remote control operation that is a detection method for a touch operation and a remote control operation for a display device including a display including a display surface, an infrared light emitting element provided at an outer peripheral portion of the display surface, and an infrared light receiving element that is provided at a position facing the infrared light emitting element at the outer peripheral portion of the display surface and is allowed to detect infrared light emitted from the infrared light emitting element and a remote control optical signal being infrared light emitted from an external infrared remote controller, the detection method including a touch operation detection step of detecting a touch operation on the display surface based on detection of the infrared light by the infrared light receiving element, a remote control signal detection step of detecting the remote control optical signal based on detection of the infrared light by the infrared light receiving element, and a process performance step of performing a first process based on detection of the touch operation by the touch operation detection step and performing a second process based on detection of the remote control optical signal by the remote control signal detection step, wherein the process performance step does not perform the first process even when the touch operation is detected in the touch operation detection step for a predetermined period after the remote control optical signal is detected in the remote control signal detection step.

The display device according to the disclosure includes the touch operation detector that detects a touch operation, the remote control signal detector that detects a remote control optical signal, and the process performer that performs the first process based on the detection of the touch operation and performs the second process based on the detection of the remote control optical signal, wherein the process performer does not perform the first process even when the touch operation detector detects the touch operation for a predetermined period after the remote control optical signal is detected by the remote control signal detector, and thus, it is possible to stably receive a remote control optical signal from an infrared remote controller using hardware related to the detection of the touch operation or to expand a range of remote control optical signals that can be supported.

The detection method for the touch operation and the remote control operation according to the disclosure also exhibit the same effects and advantages.

### BRIEF DESCRIPTION OF THE DRAWINGS

FIG. 1 is a front surface view illustrating an example of an appearance of a display device according to the disclosure.

FIG. 2 is an explanatory diagram illustrating a configuration related to touch operation detection and reception of a remote control optical signal of the display device illustrated in FIG. 1.

FIG. 3 is an explanatory diagram for a case where a state of the touch operation detection illustrated in FIG. 2 is viewed from a different direction.

FIG. 4 is an explanatory diagram illustrating a drive waveform of a touch detection LED illustrated in FIG. 2, and a state where detection of a touch operation and detection of a remote control optical signal in synchronization with the drive waveform are performed in a time-division manner.

FIG. 5 is an explanatory diagram illustrating an example of processing performed by a processor of a main control circuit illustrated in FIG. 2.

FIG. 6 is an explanatory diagram illustrating an example in which a reflective member is arranged in a non-image region of the display device illustrated in FIG. 3.

### DETAILED DESCRIPTION OF THE INVENTION

Hereinafter, the disclosure will be described in further detail by using the drawings. Note that the following description is in all aspects illustrative and should not be understood as limiting the disclosure.

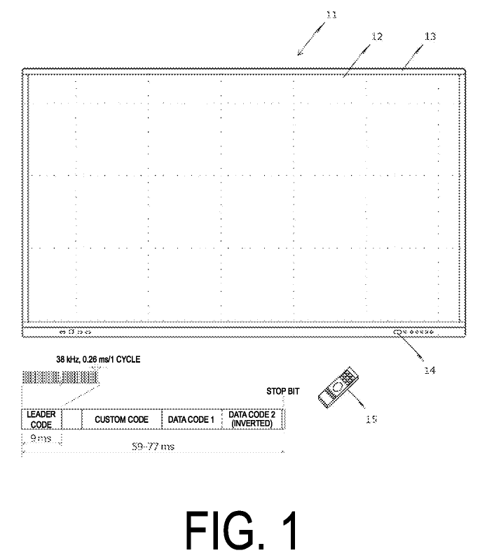

FIG. 1 is a front surface view illustrating an example of an appearance of a display device according to the disclosure. A display device 11 illustrated in FIG. 1 includes a display 12 having a glass surface and a frame portion 13 that is a portion surrounding an outer periphery of the surface (display surface) of the display 12. The frame portion 13 below the display 12 is provided with, in addition to a remote control signal light receiver 14, an operation switch, and a display lamp. The remote control signal light receiver 14 is provided to constantly detect infrared light (a remote control optical signal) emitted from an infrared remote controller 15 in response to an operation on the infrared remote controller 15 which is a separate body attached to the display device 11. The infrared remote controller 15 is used for turning on/off of power of the display device 11, switching of input, operations related to a setting menu, operations related to a display cursor, and operations such as movement of the display cursor. When the infrared remote controller 15 receives an operation by a user, the infrared remote controller 15 emits a remote control optical signal corresponding to the operation.

Several formats are known for the remote control optical signals used by the infrared remote controller 15 to transmit operation information. Typical formats include the NEC format, the Consumer Electronics Association format, the Sony format, and the like. For example, in the NEC format, information made of 1 and 0 (bit data) is carried on an optical signal which flashes at 38 kHz (a cycle of 26.3 μs), and a data string for one frame is sent in a predetermined format. As illustrated in FIG. 1, the format is made of a data string of about 59 to 77 ms in total, in which a head of one frame is a leader code of about 9 ms, followed by a custom code of 16 bits, a data code 1 of 8 bits, a data code 2 of 8 bits, and a stop bit indicating an end, in that order. The custom code is a manufacturer identification code, and the data code 2 is obtained by bit-inverting the data code 1.

For example, when any of operation buttons is pressed, the infrared remote controller 15 repeatedly emits remote control optical signals of a data code corresponding to the pressed operation button for a number of frames during that period. Note that the custom code is predetermined as data unique to a manufacturer or a product, to cause no response to be made to a remote control optical signal for another manufacturer or another product having a different custom code. Further, the NEC format and other formats are different in a flashing cycle of an optical signal, a frame configuration, and the like. Basically, no response is made to a remote control optical signal for another manufacturer or another product for which a different format is adopted.

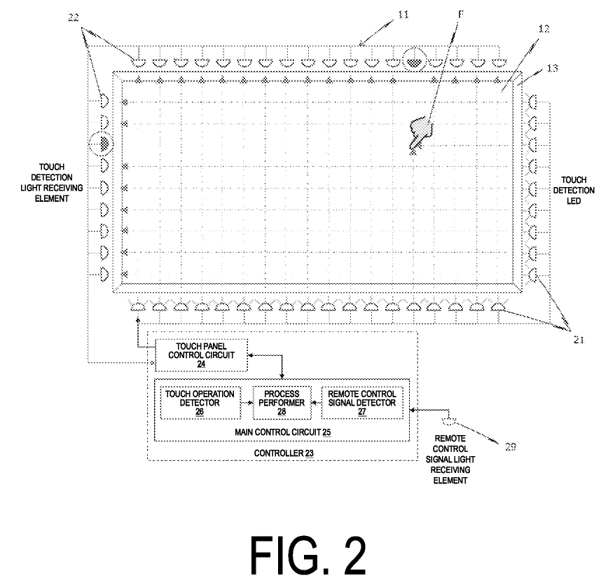

FIG. 2 is an explanatory diagram illustrating a configuration related to touch detection and reception of a remote control optical signal of the display device illustrated in FIG. 1. As illustrated in FIG. 2, a plurality of touch detection LEDs 21, each of which is an infrared light emitting element, and a plurality of touch detection light receiving elements 22 are arranged to face each other at the frame portion 13 of the display device 11. To be specific, the plurality of touch detection LEDs 21 are arranged at the frame portion 13 on a right side of the display 12, and the plurality of touch detection light receiving elements 22 are arranged at the frame portion 13 on a left side of the display 12 so as to face the plurality of touch detection LEDs 21. As indicated by a two-dot chain line in FIG. 2, the touch detection LED 21 and the touch detection light receiving element 22 facing each other form a pair in a left-right direction.

Similarly, the plurality of touch detection LEDs 21, each of which is the infrared light emitting element, are arranged at the frame portion 13 on a lower side of the display 12, and the plurality of touch detection light receiving elements 22, each of which is the infrared light receiving element, are arranged at the frame portion 13 on an upper side of the display 12 so as to face the plurality of touch detection LEDs 21. As indicated by a two-dot chain line in FIG. 2, each touch detection LED 21 and the touch detection light receiving element 22 form a pair in an up-down direction. As illustrated in FIG. 2, when a finger F touches the display 12, infrared light from the touch detection LED 21 is blocked by the finger F, and does not reach the touch detection light receiving element 22 paired therewith, or reaches the touch detection light receiving element 22 but an amount of received light is reduced, and thus a position of the touch operation can be located by detecting the change.

The processing of locating the position of the touch operation is performed by a controller 23 illustrated as a block in FIG. 2. In the example illustrated in FIG. 2, the controller 23 includes a touch panel control circuit 24 and a main control circuit 25. The touch panel control circuit 24 includes a drive circuit that causes the touch detection LEDs 21 to sequentially and intermittently emit light, and a circuit that detects received light intensity of infrared light received by the respective touch detection light receiving elements 22 paired with the touch detection LEDs 21. The touch panel control circuit 24 may be arranged at the frame portion 13 and connected to the main control circuit 25 arranged on a back side of the display 12 by serial communication using a universal serial bus (USB), a universal asynchronous receiver transmitter (UART), or the like.

The main control circuit 25 controls the entire display device 11 including the setting menu and display. Further, the main control circuit 25 includes a touch operation detector 26, a remote control signal detector 27, and a process performer 28. The touch operation detector 26 generates a drive signal for causing the touch detection LED 21 to intermittently emit light, and provides the drive signal to the touch panel control circuit 24. In addition, received light intensity of each touch detection light receiving element 22 detected by the touch panel control circuit 24 is acquired in synchronization with flashing of the touch detection LED 21. Then, presence or absence of a touch operation is determined based on the acquired received light intensity of each touch detection light receiving element 22. The remote control signal detector 27 determines whether a remote control optical signal is received or not, and when determining that a remote control optical signal is received, detects a command included in the remote control optical signal. The remote control signal detector 27 processes not only a remote control optical signal received by a remote control signal light receiving element 29 provided at the remote control signal light receiver 14 but also a remote control optical signal received by the touch detection light receiving element 22. However, detection of a remote control optical signal using the remote control signal light receiving element 29 is always performed, but detection of a remote control optical signal using the touch detection light receiving element 22 is performed while the touch operation is not being detected. Details will be described below.

The process performer 28 performs a first process based on a touch operation detected by the touch operation detector 26 and performs a second process based on a remote control optical signal from the infrared remote controller 15 detected by the remote control signal detector 27 using the touch detection light receiving element 22. The first process related to a touch operation may include, for example, processing of determining a position of the touch operation. Further, processing of determining a type of touch operation (tap, double tap, pinch, or the like), or processing of updating a display content in accordance with the type of touch operation may also be included. The second process may include processing of recognizing a content of a command included in a received remote control optical signal. Further, processing of turning on/off of power, switching of input, displaying or updating of the setting menu, updating of the display cursor, or the like according to the content of the command may also be included.

The main control circuit 25 of the disclosure includes a processor and a memory as hardware resources. The processor of the main control circuit 25 reads and executes a control program stored in advance in the memory, thereby enabling control of the entire display device 11 including the touch operation detector 26, the remote control signal detector 27, and the process performer 28. Note that the configuration of the controller 23 illustrated in FIG. 2 is merely an example, and for example, the touch panel control circuit 24 and the main control circuit 25 may be configured as one circuit, or the main control circuit 25 may be configured with a plurality of circuits. Further, the sharing of the processing by the touch operation detector 26, the remote control signal detector 27, and the process performer 28 is merely an example.

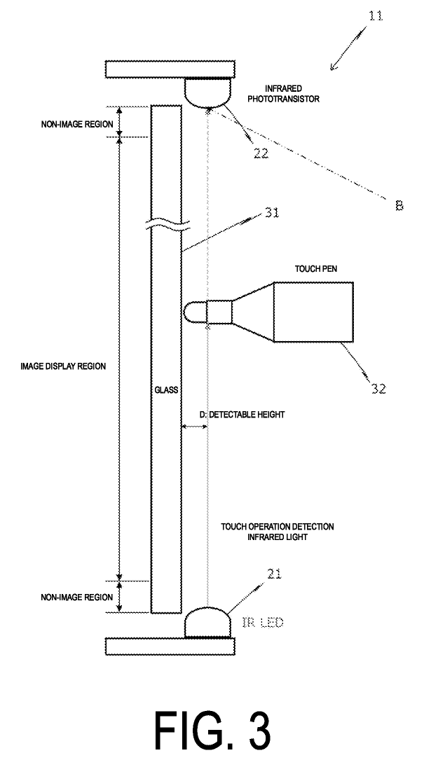

FIG. 3 is an explanatory diagram for a case where a state of the touch operation detection illustrated in FIG. 2 is viewed from a different direction. FIG. 3 illustrates a state where the touch detection LED 21 and the touch detection light receiving element 22 that are paired in the up-down direction are viewed in a direction on a left side along a display surface 31 that is the surface of the display 12 in FIG. 2. Although FIG. 2 illustrates a case where the finger F of the user touches the display surface 31, a touch operation can also be detected in a case where a touch pen 32 touches the display surface 31 as illustrated in FIG. 3 instead of the finger F of the user. The touch detection LED 21 and the touch detection light receiving elements 22 that are paired are arranged at positions separated from the display surface 31 by a predetermined distance D. In FIG. 3, the distance D is illustrated as a detectable height. When a tip end portion of the touch pen 32 approaches the display surface 31 within the distance D, infrared light from the touch detection LED 21 is blocked by the touch pen 32, and does not reach the paired touch detection light receiving element 22 or reaches the touch detection light receiving element 22 but an amount of received light is reduced, therefore, a position of the touch operation can be located by detecting the change.

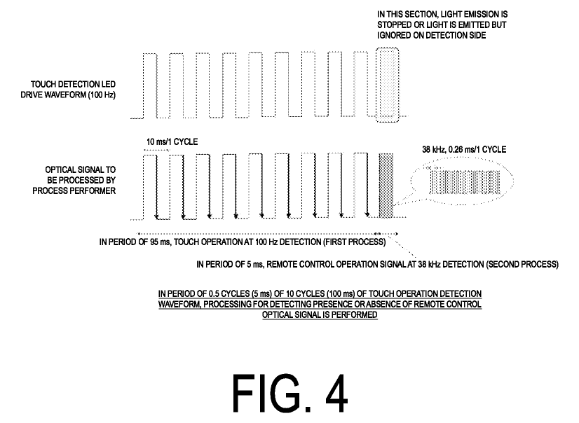

FIG. 4 is an explanatory diagram illustrating a drive waveform of the touch detection LED, and a state where the processor of the main control circuit 25, as the touch operation detector 26 and the remote control signal detector 27, performs detection of a touch operation and detection of a remote control optical signal in synchronization with the drive waveform in a time-division manner. In the example illustrated in FIG. 4, the touch panel control circuit 24 drives each touch detection LED 21 to flash at a frequency of 100 Hz (a cycle of 10 ms). The touch operation detector 26 repeatedly determines presence or absence of a touch operation, in synchronization with a period during which each touch detection LED 21 is turned on, based on received light intensity of the paired touch detection light receiving element 22. However, during a period of 0.5 cycles (5 ms) of 10 cycles (100 ms), the processor, as the remote control signal detector 27, determines whether each touch detection light receiving element 22 receives a remote control optical signal.

As an example of a format of the remote control optical signal, FIG. 1 illustrates the NEC format. With the NEC format, although it is not possible to receive all of one frame of remote control optical signals during the period of 5 ms, it is possible to determine whether optical signals of a pulse train flashing at a frequency of 38 kHz are received or not. According to this aspect, even when infrared light for touch operation detection and a remote control optical signal from the infrared remote controller 15 that are flashing at different frequencies are simultaneously received, the touch operation detector 26 can determine presence or absence of a touch operation in synchronization with a frequency of the infrared light for touch operation detection, and the remote control signal detector 27 can determine presence or absence of the remote control optical signal using the touch detection light receiving element 22 in synchronization with the frequency of the remote control optical signal. As illustrated in FIG. 4, the processor of the main control circuit 25 repeats the detection of a remote control optical signal during the period of 5 ms in the cycle of 100 ms. When determining that a remote control optical signal is detected, the processor performs the second process related to the remote control optical signal. Note that even when the touch operation detector 26 detects a touch operation, the first process based on the detection is not performed until a predetermined period elapses after the remote control optical signal is detected. According to this aspect, when a remote control optical signal is detected, performance of the first process related to a touch operation is postponed for the predetermined period, and the second process related to the remote control optical signal can be preferentially performed. It is assumed that the user of the display device 11 does not normally perform a touch operation on the display surface 31 while operating the infrared remote controller 15. Therefore, even in this case, it is unlikely that a substantial problem such as not responding to a touch operation occurs, and it is rather considered that a remote control optical signal can be stably received or a range of remote control optical signals that can be supported can be expanded.

In the example illustrated in FIG. 4, the processor of the main control circuit 25 as the remote control signal detector 27 detects a remote control optical signal in the period of 5 ms in the cycle of 100 ms. When determining that a remote control optical signal is detected during the period, the processor performs the second process related to the remote control optical signal based on the detection. As illustrated in FIG. 1, one frame of remote control optical signals is formed of a data string of about 59 to 77 ms. For example, when detecting a remote control optical signal, the processor receives, as the second process, at least one entire frame of the remote control optical signals. Then, the processing based on the detection of the remote control optical signal is started. During a period until the remote control optical signals of at least one frame are received and a content of a command included in the received remote control optical signals is recognized, even when a touch operation is detected, the first process based on the detection of the touch operation is not performed, and performance of the second process based on the detection of the remote control optical signals is continued. It is also possible not to perform the first process until the second process is completed, instead of the period until the content of the command is recognized. In other words, when a remote control optical signal is detected, the processor postpones performance of the first process based on detection of a touch operation, and performs the second process based on the detection of the remote control optical signal.

### Flowchart

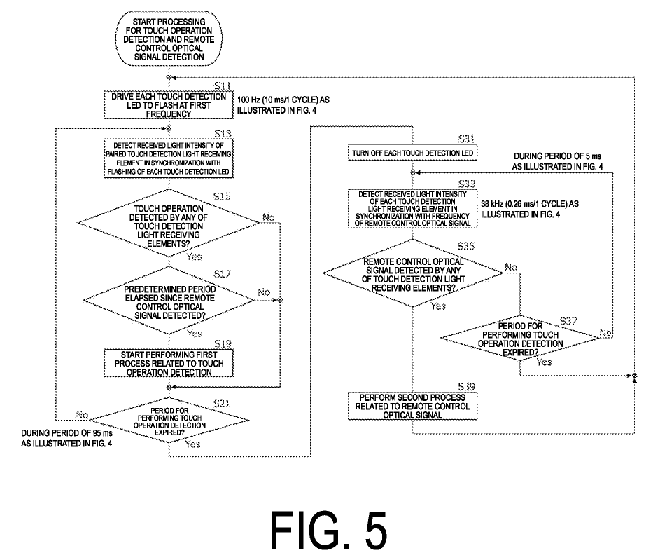

Hereinafter, an example of processing performed by the processor of the main control circuit 25 will be described with reference to a flowchart. FIG. 5 is an explanatory diagram illustrating an example of the processing performed by the processor of the main control circuit. As illustrated in FIG. 5, the processor as the touch operation detector 26 starts driving each touch detection LED 21 to flash at a first frequency (step S11). In the example illustrated in FIG. 4, a waveform of the flashing drive has the frequency of 100 Hz, and the one cycle of 10 ms. Then, in synchronization with the flashing of the touch detection LEDs 21, received light intensity of infrared light received by each touch detection light receiving element 22 is detected (step S13). Then, as illustrated in FIG. 2 or 3, it is found out whether infrared light incident on any of the touch detection light receiving elements 22 is blocked by a touch operation and the received light intensity is lowered or not, that is, whether a touch operation is detected or not (step S15).

When determining that a touch operation is detected (Yes in step S15), the processor as the process performer 28 checks whether a predetermined period elapses after the remote control optical signal is detected or not (step S17). The checking of whether the predetermined period does not elapse after the remote control optical signal is detected or not may be enabled by starting time measurement using a predetermined timer, for example, when the determination of step S35 described below results in Yes. The predetermined period in this case is literally a period for checking time that elapses after the touch operation is detected. However, when the predetermined period means, for example, a period from when a remote control optical signal is detected to when remote control optical signals for one frame are received based on the detection and a command is recognized, it is sufficient to enable checking of a period from when the determination of step S35 described below is started to when the command is recognized using, for example, a flag or the like. Similarly, when the predetermined period means, for example, a period from when the remote control optical signal is detected to when the second process is ended based on the detection, it is sufficient to enable checking using, for example, a flag or the like.

When the predetermined period elapses after the remote control optical signal is detected (Yes in step S17), the processor as the process performer 28 starts performance of the first process related to the touch operation (step S19). On the other hand, when the predetermined period does not elapse after the remote control optical signal is detected (No in step S17), the first process in step S19 is skipped. The first process is, for example, a process of determining a position of the touch operation. Then, processing is caused to be started for performing turning on/off of power, switching of input, displaying and updating of the setting menu, updating of the display cursor, and the like in accordance with a content of the command. A configuration may be adopted in which the processing operations for performing turning on/off of the power, switching of the input, displaying or updating of the setting menu, updating of the display cursor, and the like are started as tasks related to the first process under a multi-task environment, for example, and these tasks are performed. In principle, the task related to the first process is processing that is to be ended within one cycle in which the touch detection LED 21 flashes, and is to be repeatedly performed for each cycle.

The processor as the touch operation detector 26 determines whether a period for detecting a touch operation expires or not (step S21). In the example illustrated in FIG. 4, it is determined whether a period of 95 ms expires or not. When the period does not expire (No in step S29), the processor returns the processing to step S13 described above, and continues the detection of received light intensity of each touch detection light receiving element 22, that is, the detection of a touch operation in synchronization with the flashing of the touch detection LED 21. On the other hand, when the period for detecting a touch operation expires (Yes in step S21), the processing is subsequently switched to detection of a remote control optical signal. Specifically, the processing proceeds processing of step S31 described below.

In step S31, the processor as the remote control signal detector 27 turns off each touch detection LED 21. However, the processing of step S31 may be omitted. In this case, in the example illustrated in FIG. 4, each touch detection LED 21 enters an illuminated state during the period of 5 ms during which the second process is being performed. Then, the processor detects received light intensity of infrared light received by each touch detection light receiving element 22 at timing in synchronization with a frequency of the remote control optical signal (step S33). In the example illustrated in FIG. 4, a frequency of the remote control optical signal is 38 kHz, and one cycle is 0.26 ms. Then, it is found out whether a remote control optical signal is detected or not (step S35).

When determining that a remote control optical signal is not detected (No in step S35), the processor as the remote control signal detector 27 determines whether a period for detecting a remote control optical signal expires or not (step S37). In the example illustrated in FIG. 4, it is determined whether the period of 5 ms expires or not. When the period does not expire (No in step S37), the processor returns the processing to step S33 described above and repeats the detection of a remote control optical signal. On the other hand, when the period for detecting a remote control optical signal expires (Yes in step S37), the processor returns the processing to step S11 described above, starts driving each touch detection LED 21 to flash, and repeats performance of processing related to a touch operation.

When determining in the determination of step S35 described above that a remote control optical signal is detected (Yes in step S35), the processor as the process performer 28 performs processing based on the detection of the remote control optical signal using the touch detection light receiving element 22 (step S39). This is processing of acquiring a command related to the remote control optical signal.

In order to acquire the command related to the remote control optical signal, it is necessary to continuously receive remote control optical signals for at least one frame. In the example of the NEC format illustrated in FIG. 1, a period of 59 to 77 ms is required. Therefore, the period for detecting the presence or absence of the remote control optical signal (the period of 5 ms in the example illustrated in FIG. 4) is insufficient for the processing of step S39 for acquiring the command related to the remote control optical signal. When the processor detects a remote control optical signal, the processor receives remote control optical signals for at least one frame and performs processing related to the remote control optical signals. It is clear that the period for detecting presence or absence of a remote control optical signal (the period of 5 ms in the example illustrated in FIG. 4) is exceeded at a point in time when the processing of step S39 is completed. Therefore, the processor returns the processing to step S11 described above, starts driving each touch detection LED 21 to flash, and repeats the performance of the processing related to a touch operation. Note that unlike the example illustrated in FIG. 4, when there is a possibility that the processing of the step S39 is completed within the period for detecting presence or absence of a remote control optical signal, the determination of the step S37 may be performed at a point in time when the processing of the step S39 is completed. The above is the processing as illustrated in FIG. 5.

### Embodiment 1

In the disclosure, the infrared remote controller 15 attached to the display device 11 may detect a remote control optical signal using the touch detection light receiving element 22 and perform the second process related to the remote control optical signal. That is, in this embodiment, an object for a remote control optical signal to be detected by the touch detection light receiving element 22 may be the same as that for the remote control signal light receiving element 29. In this case, the touch detection light receiving element 22 can be said to extend the remote control signal light receiving element 29. For example, when a viewing angle at which the remote control signal light receiver can receive light is narrow due to a narrow frame, the viewing angle at which light can be received can be extended by detecting a remote control optical signal using the touch detection light receiving element 22.

### Embodiment 2

In Embodiment 1, it is assumed that a remote control optical signal from the infrared remote controller 15 attached to the display device 11 is detected using the touch detection light receiving element 22. Unlike Embodiment 1, a configuration may be adopted in which an infrared remote controller different from the attached infrared remote controller 15 is usable. Here, the different infrared remote controller may emit a remote control optical signal in a different format. As described above, even when a remote control optical signal for which a different format is adopted is received, the display device 11 does not respond. However, the display device 11 can detect infrared light using not only the remote control signal light receiving element 29 but also the touch detection light receiving element 22. Therefore, a remote controller of the attached infrared remote controller 15 is enabled to receive a remote control optical signal using the remote control signal light receiving element 29, and a remote controller for a different format is enabled to receive a remote control optical signal using the touch detection light receiving element 22.

It is sufficient to allow in advance the user to set which function of the display device 11 is assigned to each operation button of the infrared remote controller of a different format by the setting menu of the display device 11. The setting menu receives a remote control optical signal corresponding to each operation button by the operation button of the infrared remote controller of a different format being pressed, then receives the setting of the function of the display device 11 to be assigned to the received remote control optical signal. As an operation on the setting menu at the time, it is sufficient to use a touch operation of a main body of the display device 11, or the attached infrared remote controller 15. In this way, for example, in a public place, only a limited function of the display device 11 can be allowed to be operated by an unspecified number of people, or in a classroom of a school or the like, only a limited function of the display device 11 can be allowed to be operated by a teacher or a student.

Although the case of the infrared remote controller of a different format has been described as an example, the disclosure is not limited to this, and the infrared remote controller may have the same format as the attached infrared remote controller 15. As far as a custom code is different from that of the attached infrared remote controller 15, identification as the attached infrared remote controller 15 is possible, and therefore, it is sufficient that a remote control optical signal is received using the remote control signal light receiving element 29 for the attached infrared remote controller 15, and an optical signal is received using the touch detection light receiving element 22 for a different remote controller.

### Embodiment 3

In Embodiment 1 and Embodiment 2, a remote control optical signal from the infrared remote controller is detected by using not only the remote control signal light receiving element 29 but also the touch detection light receiving element 22. However, as illustrated in FIG. 3, the touch detection light receiving element 22 is assumed to receive infrared light from the facing touch detection LED 21 along the display surface 31, and is not assumed to receive infrared light coming from a direction away from the display surface 31, for example, a direction of an arrow B indicated by a two-dot chain line in FIG. 3. As a method of compensating for this point, it is conceivable to provide a reflective member 61 at an outer edge portion of the display 12 close to the touch detection light receiving element 22. Normally, pixels are arranged at the back of the glass covering the display 12, and thus are located at positions deeper than a front face of the frame portion 13. In FIG. 3, a region of the display surface where the pixels are arranged is illustrated as an image display region. A non-image region where no pixel is arranged is present around the image display region of the display 12 so that an end portion of the image display region is not hidden by the frame portion 13 even when the image display region is viewed from an oblique direction, that is, a direction shifted from a front of the display 12 in an upward, downward, leftward, or rightward direction. By providing the reflective member in the non-image region, light receiving sensitivity to infrared light coming from a direction away from the display 12 can be increased.

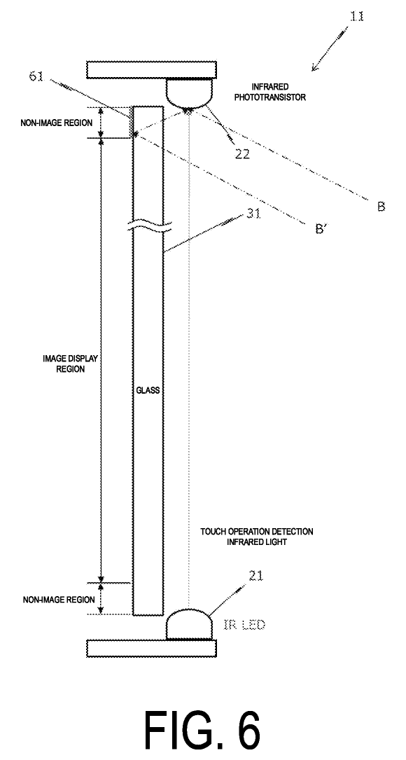

FIG. 6 illustrates a case where the reflective member 61 having a surface coated with black, for example, is arranged in the non-image region on a side close to the touch detection light receiving element 22 of the display device 11 illustrated in FIG. 3. As illustrated in FIG. 6, in addition to infrared light directly incident on the touch detection light receiving element 22 from a direction of an arrow B away from the display surface 31, infrared light reflected by the reflective member 61 near the touch detection light receiving element 22 from a direction of an arrow B' and indirectly incident on the touch detection light receiving element 22 increases. By providing the reflective member 61 in the non-image region, light receiving sensitivity to infrared light coming from a direction away from the display surface 31 is improved. According to this aspect, by providing the reflective plate behind the non-image region provided around the display surface, not only infrared light from the infrared light emitting element facing via the display surface but also a remote control optical signal coming from a direction away from the display surface and close to the front surface can be detected more reliably.

It should be understood that the disclosure also includes combinations of any of the aforementioned plurality of aspects.

Various modifications of the disclosure are also possible as well as the aforementioned embodiments. It should not be understood that the modifications do not belong to the scope of the disclosure. The disclosure should include all modifications belonging to the meaning equivalent to the scope of the claims and the scope of the disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A display device, comprising:
a display including a display surface;
an infrared light emitting element provided at an outer peripheral portion of the display surface;
an infrared light receiving element that is provided at a position facing the infrared light emitting element at the outer peripheral portion of the display surface and is allowed to detect infrared light emitted from the infrared light emitting element and a remote control optical signal being infrared light emitted from an external infrared remote controller;
a touch operation detector that detects a touch operation on the display surface based on detection of the infrared light by the infrared light receiving element;
a remote control signal detector that detects the remote control optical signal based on detection of the infrared light by the infrared light receiving element; and
a process performer that performs a first process based on detection of the touch operation by the touch operation detector and performs a second process based on detection of the remote control optical signal by the remote control signal detector, wherein
the process performer does not perform the first process even when the touch operation detector detects the touch operation for a predetermined period after the remote control optical signal is detected by the remote control signal detector.

2. The display device according to claim 1, wherein
the infrared light emitting element flashes at a first frequency to emit the infrared light,
the infrared remote controller emits the remote control optical signal of a pulse train at a second frequency different from the first frequency,
the touch operation detector detects the touch operation by determining detection of infrared light by the infrared light receiving element in synchronization with the first frequency, and
the remote control signal detector detects the remote control optical signal by determining the detection of the infrared light by the infrared light receiving element in synchronization with the second frequency.

3. The display device according to claim 1, wherein
the touch operation detector and the remote control signal detector alternately repeat and perform processing in which the touch operation detector detects the touch operation and processing in which the remote control signal detector detects the remote control optical signal at shifted times.

4. The display device according to claim 1, further comprising a reflective plate that is provided behind the display surface and reflects the remote control optical signal transmitted through the display surface, wherein
the display surface includes an image display region where an image is displayable, and a non-image region around the image display region, and
the reflective plate is provided in the non-image region of the display surface and in a vicinity of the infrared light receiving element.

5. The display device according to claim 1, further comprising a remote control signal light receiver that constantly detects a remote control optical signal emitted from an external infrared remote controller.

6. A detection method for a touch operation and a remote control operation for a display device including
a display including a display surface,
an infrared light emitting element provided at an outer peripheral portion of the display surface, and
an infrared light receiving element that is provided at a position facing the infrared light emitting element at the outer peripheral portion of the display surface and is allowed to detect infrared light emitted from the infrared light emitting element and a remote control optical signal being infrared light emitted from an external infrared remote controller, the detection method comprising:
(1) detecting a touch operation on the display surface based on detection of the infrared light by the infrared light receiving element;
(2) detecting the remote control optical signal based on detection of the infrared light by the infrared light receiving element; and
(3) performing a first process based on detection of the touch operation by step (1) and performing a second process based on detection of the remote control optical signal by step (2), wherein
step (3) does not perform the first process even when the touch operation is detected in step (1) for a predetermined period after the remote control optical signal is detected in step (2).
